(19) United States
(12) Patent Application Publication
(10) Pub. No.: US 2003/0167204 A1
(43) Pub. Date: Sep. 4, 2003

(54) Method and system for providing content items to users

(75) Inventor: Mikko Makipaa, Helsinki (FI)

Correspondence Address: Morgan & Finngan, L.L.P., 345 Park Avenue, New York, NY, 10154-0053, US

(73) Assignee: NOKIA CORPORATION, Espoo (FI)

(21) Appl. No.: 10/086,700

(22) Filed: Mar. 4, 2002

(51) Int. Cl. G06F 17/60

(52) U.S. Cl. 705/14

(57) ABSTRACT

Techniques for accumulating a collective payment for content and services from end-users include each end-user contributing to a total collective payment through one or more individual payments. A content provider receives this total collective payment. When the total collective payment is greater than or equal to a collective earning threshold, the content provider transmits the content item at a premium quality level. However, when the total collective payment is less than the collective earning threshold, the content provider transmits the content item at an impaired quality level. The content item may be transmitted at an impaired quality level in any number of ways. For instance, the content provider may reduce the size of one or more images included in the content item. Also, the content provider may increase the distortion of audio signals included in the content item. Alternatively, the content provider may even interrupt transmission of the content item to produce this impaired quality level.

### FIELD OF THE INVENTION

The present invention relates to communications. More particularly, the present invention relates to techniques for providing content items to user terminals across a communications network.

### BACKGROUND OF THE INVENTION

Communications systems currently provide end-users with the capability to purchase and receive content items made available by content providers. For example, end-users can purchase multimedia broadcasts, audio broadcasts, images, data files, electronic documents, and database entries from various content providers. Such content items are delivered across a wireless network to portable end-user devices. Examples of portable end-user devices include wireless telephones, wireless personal digital assistants (PDAs), and portable computers having wireless communications capabilities.

One way for an end-user to purchase a content item involves placing an individual payment in the form of electronic credits that are stored in the end-user's device. Accordingly, to receive a particular content item, the end-user sends a content provider a content item selection, along with an appropriate number of credits. In response, the content provider transmits the content item to the end-user.

Content providers seek to maximize incoming revenue streams from individual end-user payments that are made in exchange for the delivery of content items. However, content difficulties are often encountered in generating sufficient revenue streams. One reason for these difficulties is a mismatch between user interest and financial contribution. That is, while end-user interest in a particular content item may be high, financial contribution by end-users for the particular content item is often relatively low.

Advertising is one approach to alleviating this mismatch. In fact, many content providers currently rely on advertising to generate financial contribution from end-users. Unfortunately, advertising (even advertising that is skillfully targeted to appropriate segments of an end-user population) often fails to generate sufficient financial contribution. As a result, the advertising-based business models of many content providers are in jeopardy.

Accordingly, techniques are needed for providing content items to end-users in a manner that increases incoming revenue streams.

### SUMMARY OF THE INVENTION

The present invention provides techniques for accumulating a collective payment for content and services from end-users. Each end-user contributes to a total collective payment through a micropayment, such as a mobile payment. A content provider receives this total collective payment. When the total collective payment is greater than or equal to a collective earning threshold, the content provider transmits the content item at a premium quality level. However, when the total collective payment is less than the collective earning threshold, the content provider transmits the content item at an impaired quality level. This advantageously promotes the placement of payments by users desiring to receive the content item at a premium quality level.

The content provider may transmit the content item at an impaired quality level in any number of ways. For instance, the content provider may reduce the size of one or more images included in the content item. Also, the content provider may increase the distortion of audio signals included in the content item. Alternatively, the content provider may even interrupt transmission of the content item to produce this impaired quality level.

The collective earning threshold may be selected from a threshold function that varies during the transmission of the content item. The characteristics of this threshold function may be selected so that it optimally induces end-users to place payments.

The present invention also provides end-users with incentives for making individual payments. For instance, in aspects of the invention, the content provider awards a prize to one or more of the end-users. This prize may be awarded according to various criteria. For example, a prize may be awarded to the user that has contributed the largest of the individual user payments.

The present invention is also directed to a system for providing a content item over a network. This system includes a plurality of user terminals coupled to the network and a content provider coupled to the network. At least some of the user terminals store a payment value that is transmitted to the content provider as one of the individual user payments to at least partially pay for receiving the content item. The content provider includes one or more content items in stored in a server, a delivery management module, and a user accounts database.

The delivery management module performs communications with other entities, and performs various processing functions. These processing functions include the calculation of total collective payment values, the comparison of these values against collective earning thresholds, and the determination of quality levels and times at which content items are transmitted.

The user accounts database stores information regarding payments placed by individual end-users. The delivery management module updates these records upon actions, such as the receipt of payments, as well as the reselection and withdrawal of payments.

In addition, the present invention is directed to a device, such as a wireless communications device, for receiving a content item from a content provider. The device includes means for selecting a content item from a list of content item offerings provided by the content provider, and means for sending an individual user payment for the selected content item to the content provider. The device also includes means for receiving a revenue indicator from the content provider. this indicator indicates a comparison between a total collective payment and a collective earning threshold. The device further includes means for receiving the selected content item from the content provider in a manner that is determined by the comparison between the total collective payment and the collective earning threshold.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number.

The present invention will be described with reference to the accompanying drawings, wherein:

FIG. 1 is a block diagram of an operational environment;

FIG. 2 is a block diagram of an exemplary user terminal;

FIG. 3 is a flowchart illustrating a sequence of operation according to the present invention;

FIGS. 4 and 5 are flowcharts illustrating content item transmission techniques that are based on total collective payments;

FIG. 6 is a plot illustrating a first application of the present invention;

FIG. 7 is a flowchart illustrating interaction between a user terminal and a content provider according to a further embodiment of the present invention; and

FIG. 8 is a flowchart illustrating interaction between a user terminal and a content provider;

FIG. 9 is a block diagram illustrating an arrangement where a billing service provider facilitates the placement of payments by user terminals;

FIG. 10 is a block diagram of an exemplary content provider implementation; and

FIG. 11 is a block diagram of an example computer system.

### DETAILED DESCRIPTION OF THE PREFERRED EMBODIMENTS

I. Exemplary Operational Environment

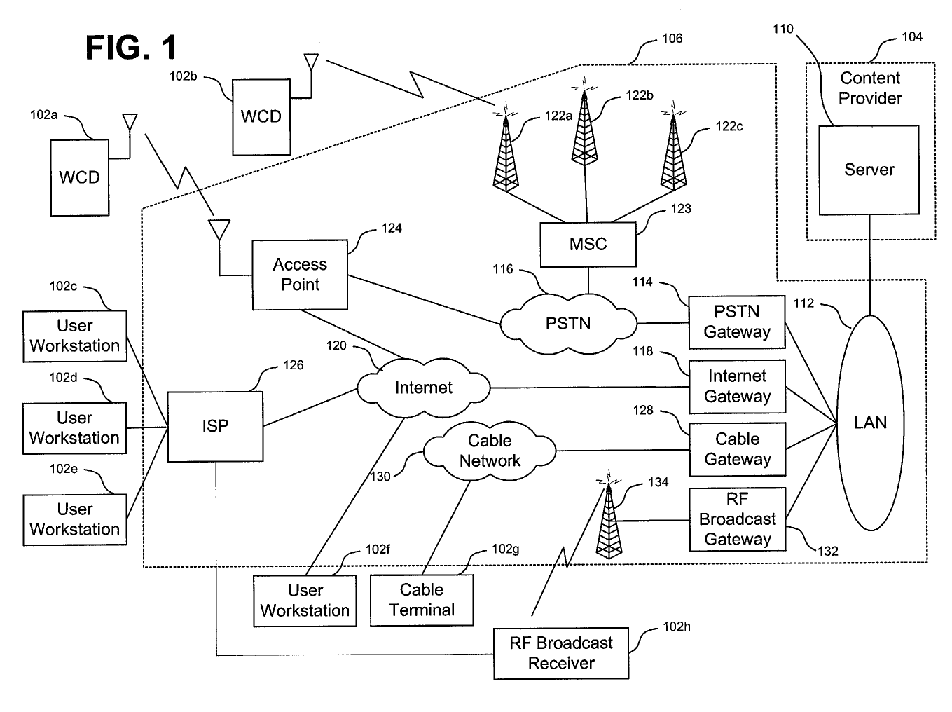

Before describing the invention in detail, it is helpful to describe an environment in which the invention may be used. Accordingly, FIG. 1 is a block diagram of an operational environment where multiple user terminals 102 request and receive content items from a content server 110 within a content provider 104 across a communications network 106.

FIG. 1 shows that communications network 106 includes a local area network (LAN) 112 that is coupled to server 110. Gateways provide LAN 112 with connectivity to backbone communications infrastructure. For example, a public switched telephone network (PSTN) gateway 114 provides connectivity with PSTN 116. Similarly, Internet gateway 118 provides connectivity with Internet 120. In addition, cable gateway 128 provides connectivity with a cable network 130. Also, a radio frequency (RF) broadcast gateway 132 provides RF connectivity with an RF broadcast network 134.

As shown in FIG. 1, communications network 106 employs various wireless and wireline technologies for user terminals 102 to exchange information with content provider 104 over these backbone networks. For instance, user terminals 102a is a wireless device that employs a short range wireless network, such as a Bluetooth personal area network (PAN) to communicate with an access point 124. User terminal 102a may alternatively employ other short range networks. For example, user terminal 102a may employ a wireless local area network (WLAN). Examples of WLAN standards include the IEEE 802.11 standard and the HIPERLAN standard.

WLANs generally offer higher available data rates and communications ranges than PANs. However, these increased data rates and communications ranges require greater power consumption. PANs and WLANs may operate in unlicensed portions of the RF spectrum, such as the 2.4 GHz Industrial, Scientific, and Medical (ISM) band, and the 5 GHz Unlicensed-National Information Infrastructure (U-NII) band.

To provide even greater communications ranges, user terminal 102b is a wireless device, such as a cellular telephone or satellite telephone, that communicates with one or more base stations 122 according to a cellular technology. Exemplary cellular technologies include Global System for Mobile Communication (GSM), IS-136 Time Division Multiple Access (TDMA) Digital Advanced Mobile Phone Service (DAMPS), Personal Digital Cellular (PDC), IS-95 Code Division Multiple Access (CDMA), General Packet Radio Service (GPRS), and broadband wireless architectures such as W-CDMA and Broadband GPRS. As shown in FIG. 1, each base station 122 is coupled to a mobile switching center (MSC) 123 that may extend user terminal 102b communications to PSTN 116 and/or Internet 120.

The operational environment of FIG. 1 also includes user terminals 102c-e, such as personal computers, that communicate with content provider 104 over wireline connections to an Internet service provider (ISP) 126. ISP 126 that provides user terminals 102c-e with access to Internet 120. The wireline connections between these terminals and ISP 126 may include dial up lines over traditional local loops and higher speed dedicated connections, such as digital subscriber lines (DSL). In addition, the operational environment of FIG. 1 includes a user terminal 102f that directly communicates with Internet 120.

FIG. 1 also shows a cable terminal 102g coupled to cable network 130. Cable terminal 102g is a device, such as a personal computer or a television equipped with a set-top box, that employs a cable modem to exchange information across cable network 130. This exchange of information may be in accordance with various standards, such as the Data Over Cable Service Interface Specification (DOCSIS). DOCSIS defines interface standards for cable modems and supporting equipment. For instance, DOCSIS specifies downstream traffic transfer rates between 27 and 36 mega bits per second (Mbps), and upstream traffic tranfer rates between 0.32 Mbps and 10 Mbps

An RF broadcast receiver 102h is also shown in FIG. 1. RF broadcast receiver 102h receives RF signals that are transmitted by RF broadcast network 134. These RF signals may convey content items furnished by content provider 104 through RF broadcast gateway 132. These RF broadcasts may be in various formats. For example, these RF broadcasts may be terrestrial television broadcasts in the DVB-T format. Alternatively, these RF broadcasts may be FM or AM radio broadcasts. RF Broadcast receiver 102h may also transmit information to content provider 104 across network 106. Accordingly, FIG. 1 shows that RF Broadcast receiver 102h is coupled to ISP 120. However, RF Broadcast receiver 102h may connect to network 106 in other ways.

It is important to note that the operational environment of FIG. 1 only illustrates examples of various user terminals and networking techniques. In fact, other technologies and standards are within the scope of the present invention. Moreover, other network topologies are within the scope of the present invention. For example, content provider 104 may be positioned in different locations so that user terminals 102 will not have to communicate across backbone networks to select and receive content items.

II. Wireless Communications Device

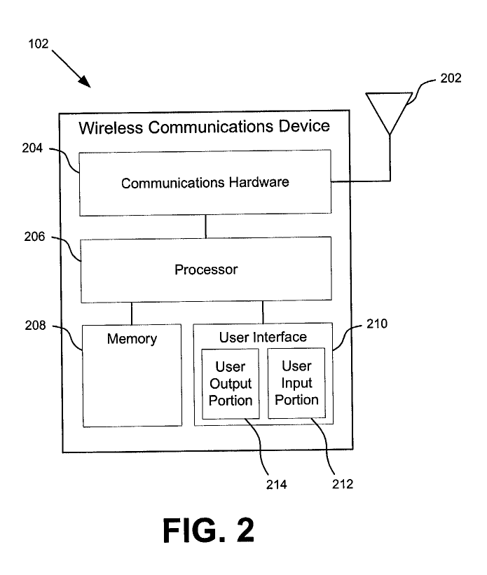

Since the present invention may be employed in environments involving wireless communications, a device capable of engaging in such communications is described. FIG. 2 is a block diagram of a wireless communications device (WCD) implementation of user terminal 102. WCD 102 may be a wireless mobile phone, a wireless PDA, a pager, a two-way radio, a smartphone, a personal communicator, or other wireless devices apparent to persons skilled in the relevant arts.

FIG. 2 shows that WCD 102 includes several components. For instance, WCD 102 includes a communications hardware portion 204 that is coupled to an antenna 202. Communications hardware portion 204 includes electronics, such as a transceiver and a diplexer. These electronics allow WCD 102 to engage in bi-directional RF communications with network entities, such as base stations and Bluetooth access points.

A processor 206 is coupled to communications hardware portion 204. Processor 206 controls all of the functions of WCD 106. Processor 206 may be implemented with one or more microprocessors that are each capable of executing software instructions stored in a memory 208.

A user interface 210 is coupled to processor 206. User interface 210 facilitates the exchange of information with a user. FIG. 2 shows that user interface 210 includes a user input portion 212 and a user output portion 214. User input portion 212 may include one or more devices that allow a user to input information. Examples of such devices include keypads, touch screens, and microphones. User output portion 214 allows a user to receive information from WCD 102. Thus, user output portion 214 may include various devices, such as a display, and one or more audio speakers. Exemplary displays include liquid crystal displays (LCDs), and video displays.

Memory 208 stores information in the form of data and software components. These software components include instructions that can be executed by processor 206. Various types of software components may be stored in memory 208. For instance, memory 208 may store software components that control the operations of communications hardware portion 204, and software components that control the exchange of information through user interface 210. In addition, memory 208 stores software components that are associated with user applications that allow WCD 102 to pay and receive content items from content provider 104.

The above components may be coupled according to various techniques. One such technique involves coupling communications hardware 204, processor 206, memory 208, and user interface 210 through one or more bus interfaces. In addition, each of these components is coupled to a power source, such as a removable and rechargeable battery pack (not shown).

As described above, memory 208 stores software components that are associated with user applications that allow WCD 102 to select and receive content items from content provider 104. Since such user applications involve the exchange of information with content provider 104, memory 208 stores software components that enables communications with content provider 104 according to protocols, such as the Wireless Application Protocol (WAP).

When engaging in WAP communications with content provider 104, WCD 102 functions as a WAP client. To provide this functionality, WCD 102 includes WAP client software, such as WAP Client Version 2.0. WAP Client Version 2.0 is a commercially available software product provided by Nokia Corporation of Finland. WAP Client Version 2.0 contains components, such as a Wireless Markup Language (WML) Browser, a WMLScript engine, a Push Subsystem, and a Wireless Protocol Stack.

Application software components stored in memory 208 of WCD 102 interact with the WAP client software to implement a variety of communications applications. Examples of such communications applications include the reception of Internet-based content, such as headline news, exchange rates, sports results, stock quotes, weather forecasts, multilingual phrase dictionaries, personal online calendars, and online travel and banking services.

WAP-enabled WCD 102 may access small files called decks which are each composed of smaller pages called cards. Cards are small enough to fit into a small display area that is referred to herein as a microbrowser. The small size of the microbrowser and the small file sizes are suitable for accommodating low memory devices and low-bandwidth communications constraints imposed by the wireless portions of communications networks, such as network 106.

Cards are written in the Wireless Markup Language (WML), which is specifically devised for small screens and one-hand navigation without a keyboard. WML is scaleable so that it is compatible with a wide range of displays that covers two-line text displays, as well as large LCD screens found on devices, such as smart phones, PDAs, and personal communicators.

WML cards may include programs written in WMLScript, which is similar to JavaScript. However, through the elimination of several unnecessary functions found in these other scripting languages, WMLScript makes minimal demands on memory 208 and processor 206.

Broadband wireless networks make it possible for WAP-enabled wireless devices to receive content items, such as video and high fidelity audio. Exemplary broadband networks include GPRS, EDGE, WCDMA, and third generation (3G) systems.

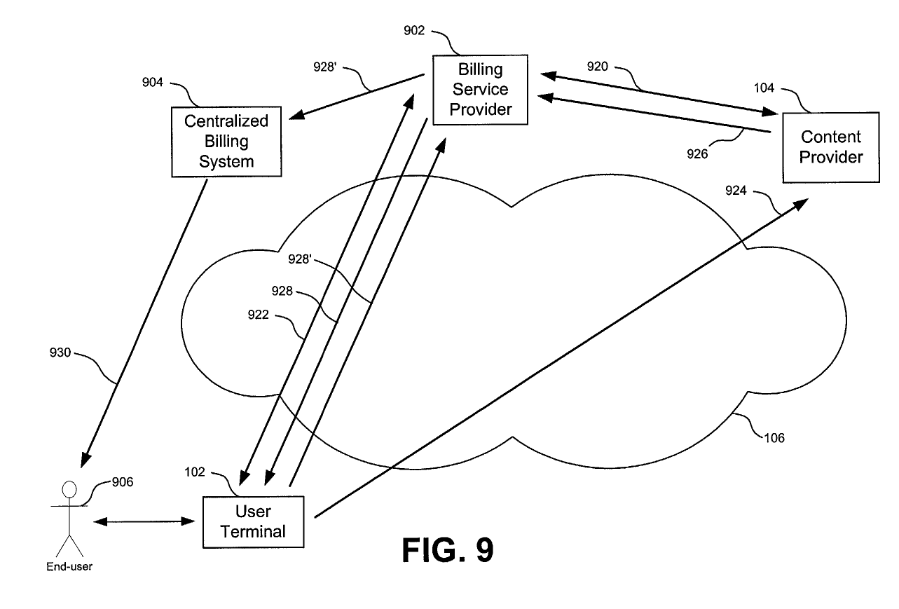

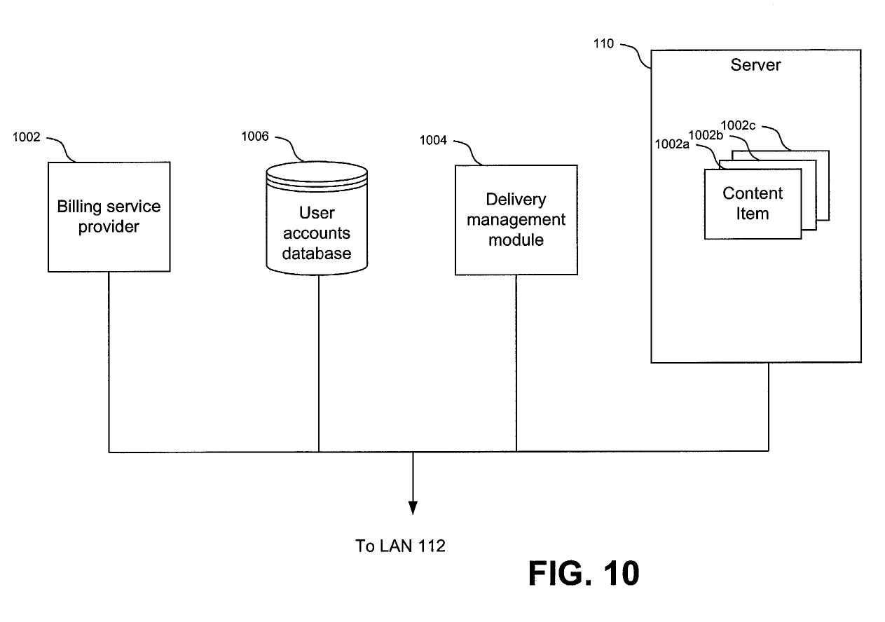

The present invention involves techniques where a user makes payments for content items. User terminals, such as WCD 102 may employ various approaches to make such payments. One such technique involves sending short messaging service (SMS) messages. Another technique involves the user of a billing service provider. These approaches are described in greater detail below with reference to FIGS. 9 and 10.

To provide for secure micropayments, WCD 102 has the ability to perform cryptographic operations to encrypt and decrypt information that it exchanges with content provider 104. Thus, payments in the form of SMS messages may be encrypted. These encryption features may be included in WAP Client software as Wireless Public Key infrastructure (PKI) features.

PKI provides infrastructure and procedures required for authentication and digital signatures for servers and mobile clients. Wireless PKI is a certificate-based system that utilizes public/private key pairs associated with each party involved in a communication.

III. Content Item Delivery

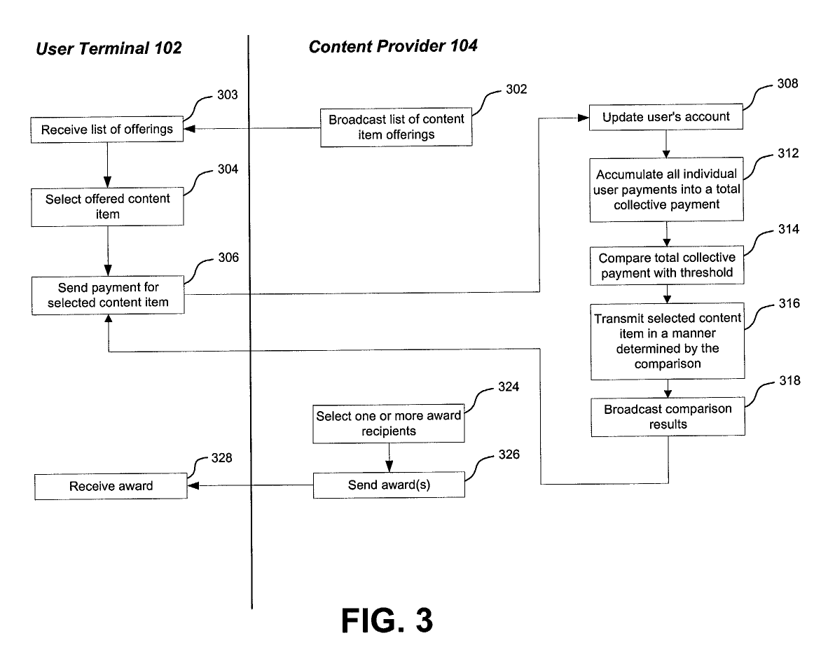

FIG. 3 is a flowchart illustrating interaction between a user terminal 102 and content provider 104 according to embodiments of the present invention. This interaction involves a single content item and a single user terminal. However, from the description provided herein, persons skilled in the relevant arts may scale this interaction to involve multiple user terminals, multiple content providers, and multiple content items.

This operational sequence begins with a step 302, where content provider 104 broadcasts a list of content item offerings. This list of content item offerings may be selected according to various techniques. In one such technique, this list of selected content items is selected so that content provider 104 may minimize costs associated with providing content items. For example, in the case of content items, such as songs, licensing arrangements may be available that offer cheaper royalties for content provider 104 to play multiple songs from the same artist. Once a song from the artist has been played, the price for the other songs of that artist could go down.

In a similar example where content provider 104 operates to deliver movies, step 302 may comprise transmitting a selection of movies that are included in cost-advantageous licensing packages. Such packages may include a few very popular movies and a larger number of less popular movies.

User terminal 102 receives this list of offerings in a step 303. Next, in a step 304, the user operating user terminal 102 selects one of the offered content items. With reference to the WCD of FIG. 2 this step may be performed through interaction with user interface 210.

In a step 306, user terminal 102 sends a payment for the selected content item. This payment is also referred to herein as a micropayment. The micropayment may be in an amount that is selected by the user. The user may freely select this amount. Alternatively, this amount may be a multiple of a fixed base-amount.

Content provider 104 receives this micropayment, and in a step 308, updates the account of user terminal 102 to reflect receipt of the micropayment. Next, in a step 312, content provider 104 accumulates all individual user payments into a total collective payment. This total collective payment quantifies the amount of user contribution from a population of user terminals that placed micropayments for this service. Thus, step 312 comprises content provider 104 summing a plurality of individual user payments.

A step 314 follows step 312. In this step, content provider 104 compares the total collective payment with a threshold value that is referred to herein as a collective earning threshold. Accordingly, step 314 may comprise calculating a difference between the total collective payment and the collective earning threshold.

Steps 312 and 314 may correspond to a single content item. Alternatively, steps 312 and 314 may correspond to multiple content items. For example, step 312 may include accumulating user payments that are placed for the content item selected in step 304. In this case step 314 includes comparing the total collective payment with a collective earning threshold that also corresponds to the content item selected in step 304.

In the alternative arrangement step 312 may include accumulating user payments that correspond to a set of content items. In this case, step 314 includes comparing the total collective payment with a collective earning threshold that also corresponds to this set of content items.

The collective earning threshold may be selected according to various techniques. For instance, this threshold may be selected from a time-varying threshold function that provides a threshold value for each moment during the transmission of a content item. Alternatively. the collective earning threshold may be a fixed parameter that changes (if at all) at infrequent intervals.

Such collective earning thresholds may be determined according to various techniques. In one such technique, this threshold is based on estimated content item costs and desired profit margins. These estimated content item costs may be determined from current information, such as existing licensing deals. In addition, these estimated costs may be determined from historical data, such as the revenue generated during previous offerings of the content item.

Moreover, the collective earning threshold may be dynamically adjusted based on revenue generated from one or more content items. As this revenue increases, the need for additional revenue is not as critical. Therefore, when such increases occur, the corresponding collective earning threshold may be reduced. Conversely, when revenue generated from one or more content items decreases, the corresponding collective earning threshold may be increased.

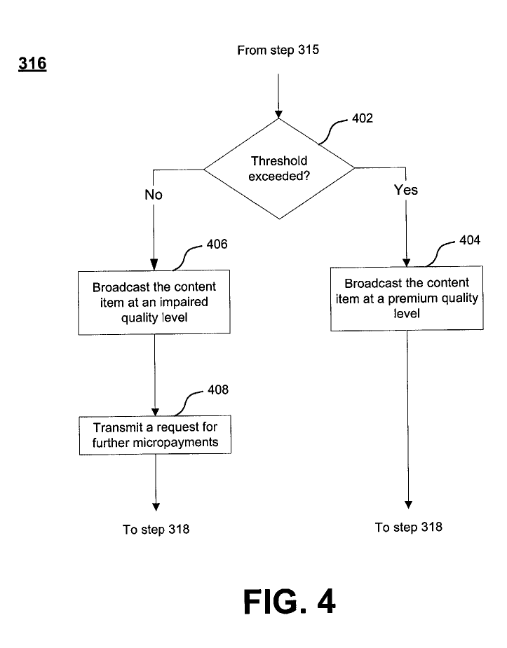

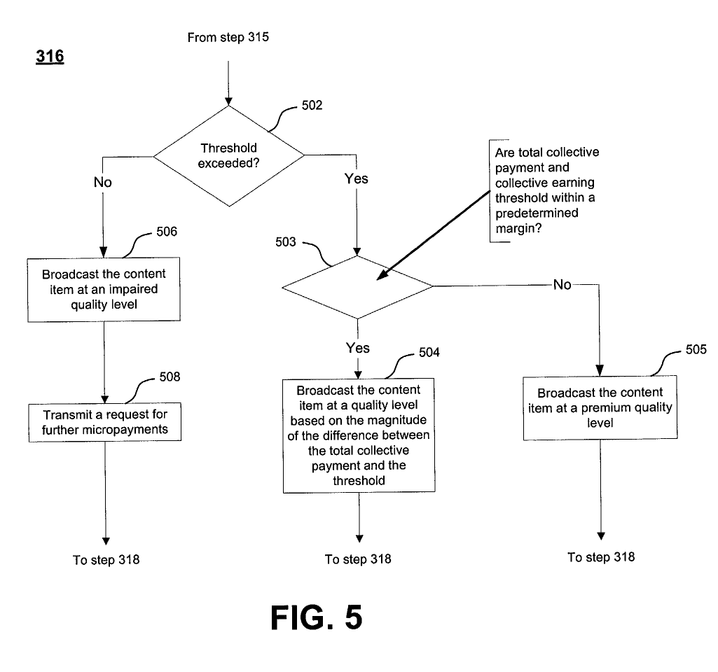

Next, in a step 316, content provider 104 transmits the content item in a manner determined by this comparison. Details regarding the performance of step 316 are provided below with reference to FIGS. 4 and 5.

In a step 318, content provider 104 transmits the result of the comparison performed in step 314. These results may be transmitted in any number of formats. For example, this transmission may be in the form of a super teletext page, which can offer users image-rich interactive applications. These transmitted results may indicate collective earning threshold and total collective payment values. Alternatively, these transmitted results may show only total collective payment to collect earning threshold ratios. Such ratios may be indicated as percentages.

To further encourage the payment for content items, embodiments of the present invention provide incentives to individual users in the form of awards. Examples of awards include monetary awards, and electronic credits for future micropayments. Another example of an award is the giving of publicity to comments or content provided by individual user(s). For example, individual users may include a comment and/or content (such as multimedia, sound clips, images, etc.) to their payments made pursuant to step 306. As the reward, the comments from a selected award recipient may be broadcast to all viewers.

These awards are distributed after the content item has been completely delivered. However, other delivery times are within the scope of the present invention.

Accordingly, FIG. 3 shows that in a step 324, content provider 104 selects one or more award recipients. These recipients are selected according to one or more award criteria. Exemplary criteria include the user(s) that contributed the largest of the received individual payments, and user(s) that are randomly selected. After step 324, a step 326 is performed, where content provider 104 transmits an award to each of the selected award recipients.

As described above with reference to FIG. 3, content provider 104 transmits a content item in a manner based on a comparison of the total collective payment against a collective earning threshold. FIGS. 4 and 5 are flowcharts showing performances of step 316 according to embodiments of the present invention.

In FIG. 4, content provider 104, according to a step 402 determines whether the total collective payment exceeds the collective earning threshold. If so, then a step 404 is performed. Otherwise, a step 406 is performed. In step 404, content provider 104 broadcasts the content item at a premium quality level. However, in step 406, content provider 104 broadcasts the content item at an impaired quality level. Transmitting content items at an impaired quality level promotes the placement of micropayments by users desiring to receive the content item at a premium quality level. Examples of premium and impaired quality levels are described below.

In addition to step 406, an optional step 408 may be performed when the total collective payment does not exceed the threshold. In this step, content provider 104 transmits a request for further micropayments. The goal of this transmission is to solicit further individual payments so that the total collective payment value is increased to a level that is greater than the threshold value. This request is transmitted to all user terminals 102.

FIG. 5 is a flowchart illustrating a performance of step 316 according to a further embodiment of the present invention. This performance is similar to the performance shown in FIG. 4. For instance, in a step 502, content provider 104 determines whether the total collective payment exceeds the collective earning threshold. If not, a step 506 is performed, where content provider 104 broadcasts the content item at an impaired quality level. In addition, an optional step 508 may be performed when the total collective payment does not exceed the threshold. As in step 408, content provider 104 transmits a request for further micropayments in step 508.

However, unlike the performance in FIG. 4, if content provider 104 determines in step 502 that the total collective payment exceeds the collective earning threshold., content provider 104 does not necessarily broadcast the content item at a premium quality level, as in step 404. In contrast, content provider 104 performs a step 503, where it determines whether the total collective payment and the collective earning threshold are within a predetermined margin. If so, content provider 104 performs a step 504 is performed. Otherwise content provider 104 performs a step 505.

In step 505, content provider 505 broadcasts the content item at a premium quality level. However, in step 504, content provider 104 transmits the content item at a quality level that is based on the magnitude of the difference between the total collective payment and the collective earning threshold. For example, as this magnitude decreases, the quality of the transmitted content item may also be reduced.

As described above with reference to FIGS. 4 and 5, content provider 104 may transmit content items at various quality levels. For instance, content items are transmitted at premium quality levels in steps 404 and 504. In contrast, content items are transmitted at impaired quality levels in steps 406, 506, and 504.

The quality level of a content item transmission relates to amount of enjoyment an end-user can derive from the content item. For instance, end-users can derive less enjoyment from a content item containing distortions and/or having attributes that impede the end-user's perception of the content item.

For audio signals, examples of such distortions and/or perception impeding attributes include noise that content provider 104 injects into audio signals. In the case of images, such distortions and/or attributes may be provided by various techniques, such as reducing image resolution, reducing image size, and injecting noise into the image. For a video stream, such distortions and/or attributes may be provided by decreasing the video stream's bandwidth. This may be implemented by changing one or more video stream encoding parameters, such as frame rate. Accordingly, steps 406, 506, and 504 may include performing these techniques to impair content item transmission quality.

According to a further technique, such distortions and/or attributes may be provided by transmitting a portion of a content item repeatedly. An example of such a portion is the beginning of a music video.

These quality impairing techniques may be employed in varying degrees. For instance, in step 504, content provider 104 transmits the content item at a quality level that is based on the difference between the total collective payment and the collective earning threshold. This may be implemented, for example, by varying the amount of noise injection, varying image size, and/or varying image in a manner that is proportional to this difference.

Also, as described above with reference to FIG. 5, content item quality is impaired in both steps 506 and 504. However, quality is impaired to a greater degree in step 506 because step 506 is performed when the total collective payment fails to exceed the collective earning threshold. One further technique for impairing the quality of a content item is to interrupt its transmission. Accordingly, in embodiments, step 506 comprises interrupting transmission of the content item. However, in further embodiments, content item transmission may be interrupted in any combination of steps 406, 504, and 506.

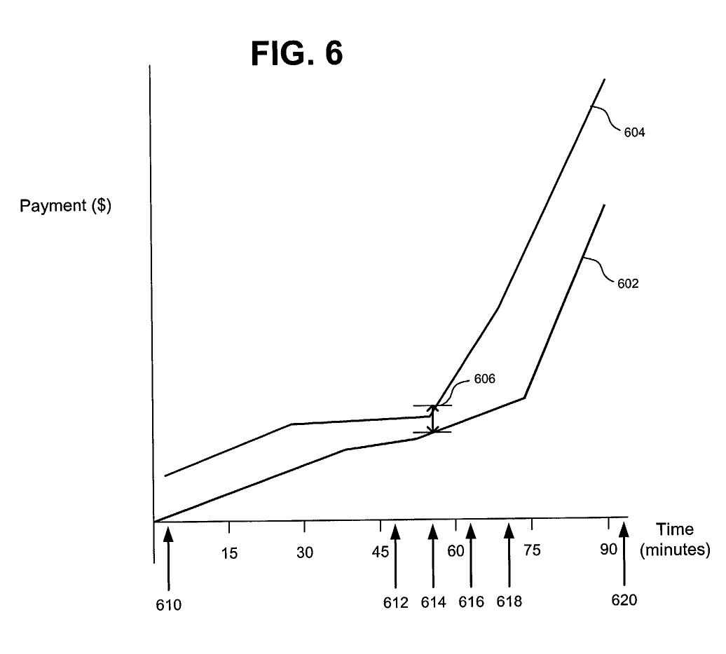

The techniques described above with reference to FIGS. 3-5 are suitable for many applications. One such application is the multi-media broadcast of a live event. Accordingly, a television broadcast of a World Cup soccer match between France and Brazil is described with reference to FIG. 6. During this broadcast, content provider 104 performs according to the techniques described in FIGS. 3 and 5. To promote the collection of individual user payments, content provider 104 employs a threshold function 602 that is shown in FIG. 6. Threshold function 602 is monotonically increasing and its slope generally increases over time.

FIG. 6 also includes a total collective payment plot 604. Thus, FIG. 6 shows how the total collective payment accumulated for this broadcast compares with the collective earning threshold at each moment during the broadcast. At the beginning of this particular broadcast, content server 104 has accumulated a substantial total collective payment because several hundreds of thousands of viewers (by performing step 306) have paid small amounts ranging in value from $0.05 to $1.00. Accordingly, FIG. 6 shows that at a time 610, the total collective payment exceeds the collective earning threshold by a substantial margin for the beginning of the soccer match. Because of this substantial margin, content provider 104 broadcasts the soccer match at a premium quality level, pursuant to step 505.

As the broadcast ensues, content provider 104 (in performing steps 312 and 314) continually accumulates the total collective payment and compares this payment against threshold function 602. Also, in performing step 318, content provider 104 may broadcast the results of such comparisons. These broadcasts may be formatted as super teletext pages displaying plots that are identical or similar to the plot of FIG. 5.

FIG. 6 shows that the total collective payment has exceeded the collective earning threshold throughout the entire first half of the soccer match. However, at the conclusion of the first half of the match (shown in FIG. 6 as time 612), no goals have been scored. Consequently, FIG. 5 shows that the stream of user payments has stabilized. This stabilization causes the total collective payment and the threshold function to converge.

As this trend of convergence progresses, the total collective payment falls within a predetermined margin 606 of the collective earning threshold. FIG. 6 shows this occurring at a time 614. Once this occurs, content provider 104 performs step 504 by reducing the quality level of the broadcast. For this application, content provider 104 reduces the size of images transmitted with the broadcast. This reduction in size progresses as the margin between the total collective payment and the collective earning threshold narrows.

Later in the broadcast, at a time 616, a good offense by the French team provokes many users to place individual payments, pursuant to step 306. Accordingly, the total collective payment and threshold function stop converging. Actually, at a time 618, the total collective payment exceeds the predetermined margin. As a result, content provider 104 performs step 505 by broadcasting the soccer match at a premium content level.

The match ends at a time 620. At this point, content provider 104 has generated a revenue stream from that not only covers costs (for example, royalty payments for broadcast rights), but also furnishes an ample profit.

As described above with reference to FIG. 3, in aspects of the invention, content provider 104 awards prizes to one or more of the end-users. In this example content provider 104 awards a prize to a user who has contributed the largest sum of individual user payments.

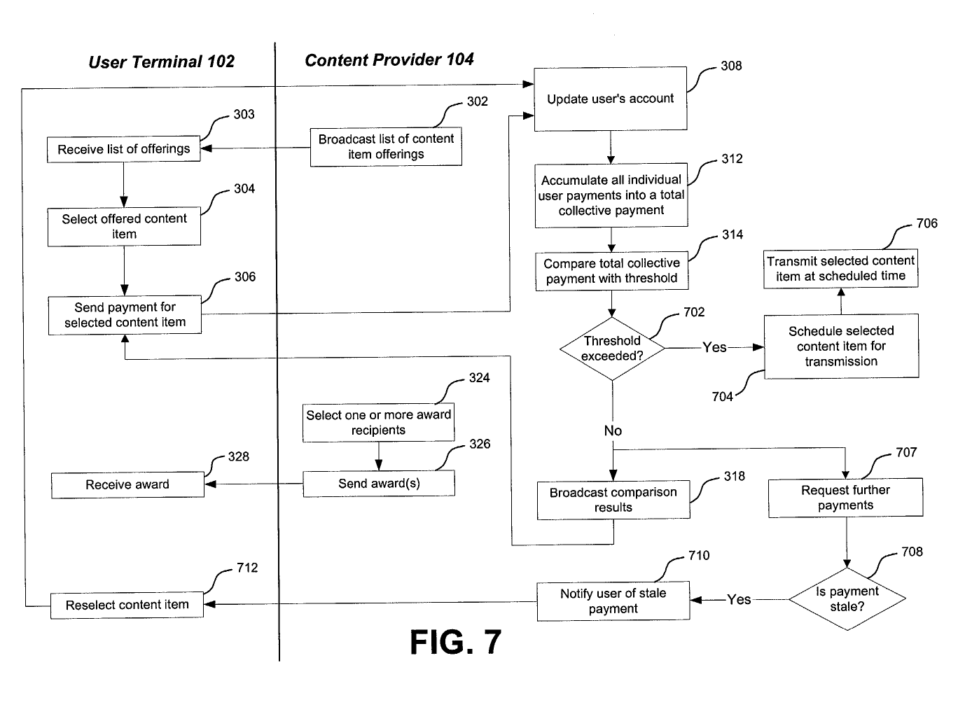

FIG. 7 is a flowchart illustrating interaction between a user terminal 102 and content provider 104 according to a further embodiment of the present invention. FIG. 7 is similar to FIG. 3. However, in FIG. 7, step 316 is replaced with steps 702-706. Also, FIG. 7 includes additional steps 707, 708, 710, and 712.

The operational sequence illustrated in FIG. 7 includes performance of steps 302-314, as described above with reference to FIG. 3. However, in FIG. 7, a step 702 follows step 314. In step 702, content provider 104 determines whether the total collective payment exceeds the collective earning threshold. If so, then steps 704 and 706 are performed. Otherwise, operation proceeds to steps 318 and 707. In step 704, content provider 104 schedules the content item for transmission. In step 706, content provider 104 transmits the content item at the scheduled time.

FIG. 7 shows that content provider 104 performs steps 318 and 707 when the total collective payment does not exceed the collective earning threshold. As described above, in step 318, the result of the comparison performed in step 314 is transmitted. In step 707, content provider 104 transmits a request for further micropayments.

Next, in step 708, content provider 104 determines whether user terminal 104 has placed any stale payments. That is, content provider 104 identifies in step 708 whether user terminal 102 has transmitted any payments for the selected content item prior to a particular time. This particular time may be determined in any number of ways. In one approach, content provider 104 subtracts an expiration period from the current time.

If content provider 104 determines in step 708 that user terminal 104 has placed one or more stale payments, it performs a step 710. In this step, content provider 104 notifies user terminal 102 that it has placed payment(s) that are now stale. This notification includes the value of the stale payments. Performance of step 710 may comprise content provider 104 transmitting information in various formats. For instance, in a mobile communications environment, step 710 may comprise content provider 104 sending a short message service (SMS) text message to user terminal 102. Alternatively, step 710 may comprise content provider 104 sending an e-mail message to user terminal 102.

Upon receipt of this notification at user terminal 102, user 102 may select a different content item. This reselection is shown in FIG. 7 as step 712. If this occurs, a reselection payment is transmitted to content provider 104 so that content provider 104 may update stored information regarding payments placed by user 102. Alternatively, upon receipt of a stale payment, user 102 may retract the payment upon receipt of notification. Such a retraction is sent to content provider 104 so that it may update stored information regarding payments placed by user 102. In a further alternative, user 102 may let the stale payments stand. In this case, the time of the payment is updated to the current time, so that content provider 104 will not immediately register these payments as stale.

The process of FIG. 7 is suitable for many applications. One such application is a voting-based radio station, where content provider 104 broadcasts music. In this case, each song or music track is a content item. Each of these content items has a particular collective earning threshold associated with it. These thresholds may determined in various ways. For example, the collective earning threshold for each song may be based on the magnitude of its required royalty payment. In this manner, old songs may have smaller thresholds than new songs.

In this application, user terminal 102 selects a song and, pursuant to step 306, places one or more payments for the selected song. As described above with reference to FIG. 7, content provider 104 only plays a song if enough payments (also referred to herein as votes) are received so that the total collective payment for the song exceeds the collective earning threshold for the song. If this occurs, content provider 104 performs steps 704 and 706, where the song is scheduled for broadcast at a scheduled time.

However, if the total collective payment for this song does not exceed its collective earning threshold within a predetermined time (such as two hours) after user terminal 102 placed its payment(s), then content provider 104 determines (by performing step 708) that these payments are stale. At this point, user terminal 102 is notified of the stale payments, and is given an opportunity to select another song in step 712.

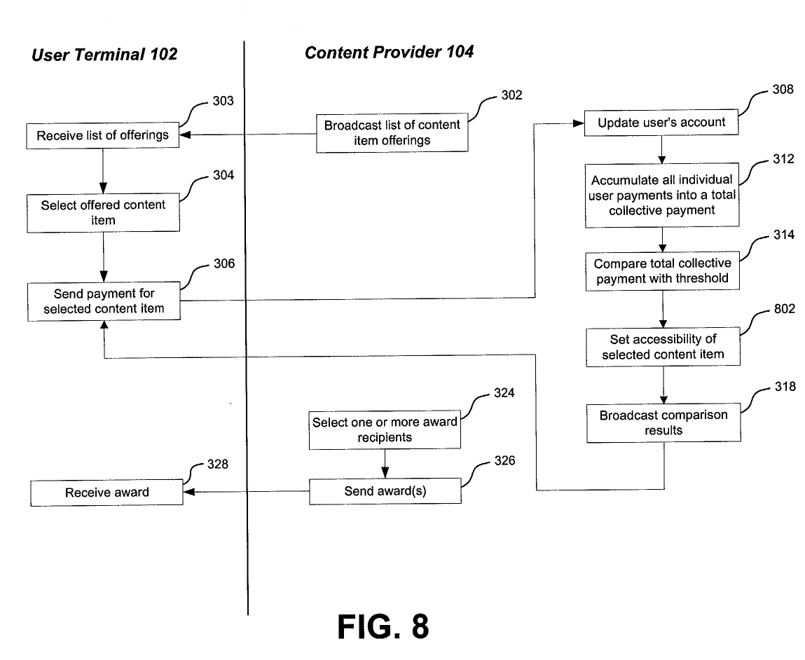

FIG. 8 is a flowchart illustrating interaction between a user terminal 102 and content provider 104 according to yet a further embodiment of the present invention. FIG. 8 is similar to FIGS. 3 and 7. For instance, in each of FIGS. 3, 7, and 8, content provider 104 performs a step 314, where it compares a total collective payment with a collective earning threshold. However, in FIG. 8, content provider 104 does not automatically transmit a content item based on such a comparison, as in FIGS. 3 and 7. Instead, FIG. 8 shows that content provider 104 makes content items available for user terminal 102 access based on such a comparison. That is, instead of operating according to a “delivery” paradigm as shown in FIGS. 3 and 7, FIG. 8 operates according to a “download” paradigm.

According to such a download paradigm. content items are made available for user terminal access according to various approaches, such as client-server communications. For example, in the case of a content item being an electronic file stored in a file server, content provider 104 may make the electronic file available by changing its access permissions, so that user terminal 104 may download the file through network 106. This technique may also be applied to other types of content items, such as file directories.

FIG. 8 is similar to FIG. 3. However, in FIG. 8, step 316 is replaced with step 802. Thus, the operational sequence of FIG. 8 includes performance of steps 302-314, as described above with reference to FIG. 3. However, in FIG. 8, a step 802 follows step 314. In step 802, content provider 104 sets the accessibility of the content item in a manner that is determined by the comparison performed in step 314. Accordingly, step 802 may include making the content item accessible to user terminals when the total collective payment is greater than the collective earning threshold. In an electronic file implementation, this step may include making a file or a file directory read and/or write accessible when the total collective payment exceeds the collective earning threshold.

As in FIGS. 3 and 7, the collective earning threshold may be selected according to various techniques in FIG. 8. In one such technique, the collective earning threshold is selected from a time varying function. However, other techniques may be employed, as would be apparent to persons skilled in the relevant arts.

IV. Payment Mechanisms

As described above, the present invention may employ various payment mechanisms. One such mechanism involves the use of a billing service provider. Accordingly, FIG. 9 is a block diagram illustrating an arrangement where a billing service provider 902 facilitates the placement of payments by user terminals 102. These payments are in the form of charge records (CDRs) that are received by billing service provider 902. These CDRs are periodically sent to a centralized billing system 904, such as one that is traditionally associated with a telephone network. Billing system 904 then periodically sends a bill to user terminal 102 for the CDRs it generated during the most recent billing cycle.

In addition to showing a network topology, FIG. 9 also illustrates a sequence of interactions between the depicted components. This interaction allows user terminal 102 to make payments as described above. Further details regarding such techniques involving these transactions are described in U.S. Pat. No. 6,047,051. This patent is incorporated herein by reference in its entirety.

This sequence of interactions begins with the establishment of certain long term contracts. These long term contracts include a contract between content provider 104 and billing service provider 902, and a contract between user terminal 102 and billing service provider 902. The establishment of the long term contract between content provider 104 and billing service provider 902 is shown in FIG. 9 as an interaction 920. In this contract, billing service provider 902 agrees to collect payments placed for content items. In return for this service, billing service provider 902 may receive financial compensation from content provider 104. As a result of the contract, each content item provided by content provider 104 is assigned a unique identifier that is recognized by both the billing service provider 902 and content provider 104 server.

An interaction 922 shows the establishment of the long term contract between content provider 104 and billing service provider 902 is shown in FIG. 9. During interaction 922, end-user 906 is assigned a unique customer identifier, which is stored by billing service provider 902 and possibly also in the server of the service provider. Also during interaction 922, end-user 906 is assigned a pair of keys consisting of a public key and a private key. This pair is used for signing and signature verification of charging records. The public key of end-user 906 is stored by billing service provider 902. However, the private key is stored in user terminal 102.

Interactions 920 and 922 may each include one or more communications that establish the terms of the associated long term contracts. These individual communication may be automatically conducted across network 106 or through other non-automated techniques.

Upon establishment of these long term contracts, user terminal 102 may begin to place payments. Accordingly, the placement of a payment, as shown in step 306 of FIGS. 3 and 7 may be performed in the manner described below with reference to interactions 924 through 928′

First, user terminal 102 sends a payment message 924 to content provider 104. Payment message 924 specifies a payment amount, a particular content item, and the unique customer identifier assigned to end-user 906. Next, content provider 104 transmits the payment amount and the unique customer identifier to billing service provider 902. This is shown in FIG. 9 as transmission 926.

Upon receiving transmission 926, billing service provider 902 generates an initial charging record (CDR) 928 and sends this record to user terminal 102. Charging record 928 contains the billing parameters associated with payment message 924. Once received at user terminal 102, end-user 906 may accept charging record 928 to complete the payment. To accept charging record 928, user terminal 102 a slightly modified charging record 928′. Charging record 928′ differs slightly from charging record 928 because it includes a digital signature. A digital signature refers to a known encryption algorithm based on a pair of keys. The encryption is done using a private key that anybody can decrypt the message using a corresponding public key. Even though the confidentiality of this message is lost, its authenticity is ensured. Therefore, end-user 906 will not be able to later deny the that he/she accepted charging record 928.

Later, billing service provider 902 sends charging record 928′ to centralized billing system 904. Periodically, centralized billing system 904 compiles received records, and accumulates an outstanding balance. This outstanding balance is sent to end-user 906 as a bill 930. Bill 930 may be sent to end-user 906 through various means, such as by conventional mail, or electronically through the Internet.

Although FIG. 9 illustrates a single billing service provider 902 operating with a single content provider 104. Other arrangements may exist. For instance, a single billing service provider 902 may interact with multiple content providers 104. In addition, the functions of content provider 104, billing service provider 902, and centralized billing system may be distributed into one or more functional elements, as would be apparent to persons skilled in the relevant arts.

As described above, a second approach for the placement of payments by user terminals 102 involves the transmission of short messaging service (SMS) messages. SMS is a service for that allows wireless devices to send and receive short text messages. When sending an SMS message, a user specifies an address. User may be charged for sending SMS messages. The present invention employs these SMS features to provide for the placement of payments.

Accordingly, the placement of a payment as shown in step 306 of FIGS. 3 and 7 may be performed in the following manner. First, a user sends a SMS message to a specific number associated with content provider 104. Next, an operator billing system, such as centralized billing system 904, identifies the user and the cost per message from the receiving number. The cost of the message is then billed from the end-user as a part of a periodic bill.

V. Content Provider

FIG. 10 is a block diagram of an exemplary implementation of content provider 104. As shown in FIG. 10, this implementation includes a plurality of content items 1002 that are stored in server 110, a delivery management module 1004, and a user accounts database 1006. Also, content provider may optionally include billing service provider 902. It is important to note, however, that the particular implementation of FIG. 10 is provided as an example. Other implementations of content provider 104 are within the scope of the present invention.

Content items 1002 may be of various types. For example, content items 1002 may be multimedia broadcasts, audio recordings, movies, television programs, images, data files, electronic documents, and database entries. However, other types of content items 1002 may be stored in server 104, as would be apparent to persons skilled in the relevant arts. Server 110 transmits these content items in a manner controlled by delivery management module 1004.

Delivery management module 1004 is responsible for communications with other entities, such as user terminals 102 and billing service providers 902. In addition, delivery management module 1004 handles the processing functions described above with reference to FIGS. 3-5, and 7. For instance, delivery management module 1004 calculates total collective payment values, and compares these values against collective earning thresholds. In addition, delivery management module 1004 determines the quality levels and times at which content items 1002 are transmitted.

User accounts database 1006 stores information regarding payments placed by individual end-users. Thus, database 1006 contains records for each end-user that places a payment. Delivery management module 1004 updates these records upon actions, such as the receipt of payments, as well as the reselection and withdrawal of payments. In addition, delivery access module accesses these records to in selecting award recipients.

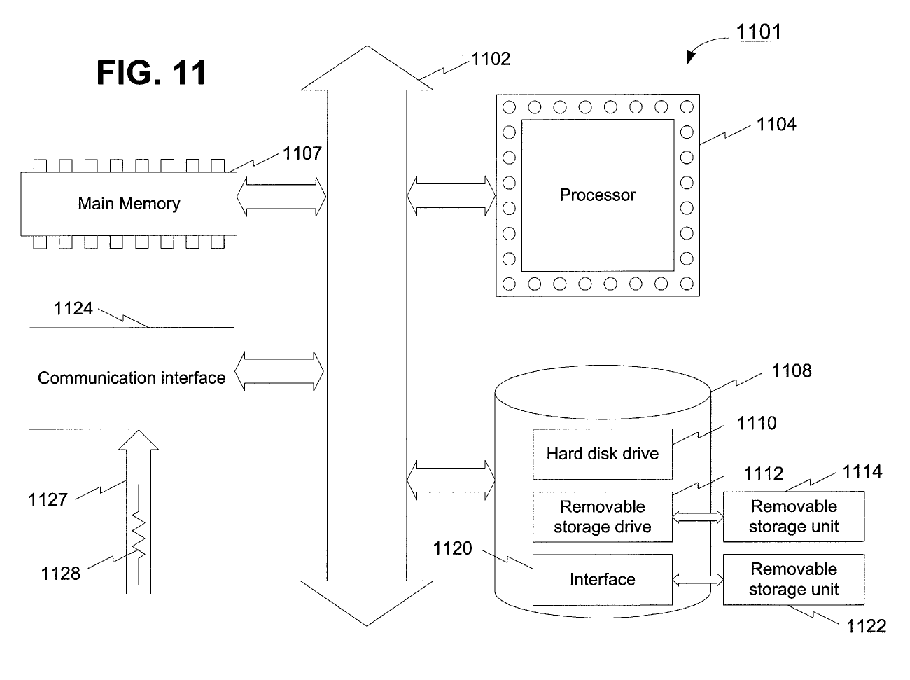

The content provider of FIG. 10 may implemented with one or more computer systems. An example of a computer system 1101 is shown in FIG. 11. Computer system 1101 represents any single or multi-processor computer. Single-threaded and multi-threaded computers can be used. Unified or distributed memory systems can be used.

Computer system 1101 includes one or more processors, such as processor 1104. One or more processors 1104 can execute software implementing the process described above with reference to FIGS. 3, 4, 5, 7, and 8. Each processor 1104 is connected to a communication infrastructure 1102 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1101 also includes a main memory 1107 which is preferably random access memory (RAM). Computer system 1101 may also include a secondary memory 1108. Secondary memory 1108 may include, for example, a hard disk drive 1110 and/or a removable storage drive 1112, representing a floppy disk drive, a magnetic tape drive, an optical disk drive, etc. Removable storage drive 1112 reads from and/or writes to a removable storage unit 1114 in a well known manner. Removable storage unit 1114 represents a floppy disk, magnetic tape, optical disk, etc., which is read by and written to by removable storage drive 1112. As will be appreciated, the removable storage unit 1114 includes a computer usable storage medium having stored therein computer software and/or data.

In alternative embodiments, secondary memory 1108 may include other similar means for allowing computer programs or other instructions to be loaded into computer system 740. Such means can include, for example, a removable storage unit 1122 and an interface 1120. Examples can include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1101.

Computer system 1101 may also include a communications interface 1124. Communications interface 1124 allows software and data to be transferred between computer system 1101 and external devices via communications path 1127. Examples of communications interface 1127 include a modem, a network interface (such as Ethernet card), a communications port, etc. Software and data transferred via communications interface 1127 are in the form of signals 1128 which can be electronic, electromagnetic, optical or other signals capable of being received by communications interface 1124, via communications path 1127. Note that communications interface 1124 provides a means by which computer system 1101 can interface to a network such as the Internet.

The present invention can be implemented using software running (that is, executing) in an environment similar to that described above with respect to FIG. 11. In this document, the term “computer program product” is used to generally refer to removable storage units 1114 and 1122, a hard disk installed in hard disk drive 1110, or a signal carrying software over a communication path 1127 (wireless link or cable) to communication interface 1124. A computer useable medium can include magnetic media, optical media, or other recordable media, or media that transmits a carrier wave or other signal. These computer program products are means for providing software to computer system 1101.

Computer programs (also called computer control logic) are stored in main memory 1107 and/or secondary memory 1108. Computer programs can also be received via communications interface 1124. Such computer programs, when executed, enable the computer system 1101 to perform the features of the present invention as discussed herein. In particular, the computer programs, when executed, enable the processor 1104 to perform the features of the present invention. Accordingly, such computer programs represent controllers of the computer system 1101.

The present invention can be implemented as control logic in software, firmware, hardware or any combination thereof. In an embodiment where the invention is implemented using software, the software may be stored in a computer program product and loaded into computer system 1101 using removable storage drive 1112, hard drive 1110, or interface 1120. Alternatively, the computer program product may be downloaded to computer system 1101 over communications path 1127. The control logic (software), when executed by the one or more processors 1104, causes the processor(s) 1104 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

VI. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of providing a content item to a plurality of users, comprising:
defining a collective earning threshold;
receiving a total collective payment from the plurality of users, wherein the total collective payment includes a plurality of individual user payments that are each contributed by a respective one of the plurality of users;
transmitting the content item at a premium quality level when the total collective payment is greater than or equal to the collective earning threshold; and
transmitting the content item at an impaired quality level when the total collective payment is less than the collective earning threshold.

2. The method of claim 1, wherein the step of defining a collective earning threshold comprises selecting a threshold value from a time-varying threshold function.

3. The method of claim 1, further comprising the step of awarding a prize to one or more of the plurality of users according to a prize criterion.

4. The method of claim 3, wherein the awarding step comprises awarding a prize to the user that has contributed the largest of the individual user payments.

5. The method of claim 1, wherein the step of transmitting the content item at a downgraded quality comprises reducing the resolution of images included in the content item.

6. The method of claim 1, wherein the step of transmitting the content item at an impaired quality comprises reducing the size of one or more images included in the content item.

7. The method of claim 1, wherein the step of transmitting the content item at an impaired quality comprises increasing the distortion of audio signals included in the content item.

8. The method of claim 1, wherein the step of transmitting the content item at an impaired quality comprises interrupting transmission of the content item.

9. The method of claim 1, further comprising the step of transmitting a request for additional individual user payments to the plurality of users when the total collective payment is less than the collective earning threshold.

10. The method of claim 1, further comprising the step of transmitting a request for additional individual user payments to the plurality of users when the total collective payment is within a predetermined range of the collective earning threshold.

11. A system for providing a content item to a plurality of users, comprising:
means for defining a collective earning threshold;
means for receiving a total collective payment from the plurality of users, wherein the total collective payment includes a plurality of individual user payments that are each contributed by a respective one of the plurality of users;
means for transmitting the content item at a premium quality level when the total collective payment is greater than or equal to the collective earning threshold; and
means for transmitting the content item at an impaired quality level when the total collective payment is less than the collective earning threshold.

12. The system of claim 11, wherein the means for defining a collective earning threshold comprises selecting a threshold value from a time-varying threshold function.

13. The system of claim 11, further comprising means for awarding a prize to one or more of the plurality of users according to a prize criterion.

14. The system of claim 13, wherein the awarding step comprises means for awarding a prize to the user that has contributed the largest of the individual user payments.

15. The system of claim 11, wherein the means for transmitting the content item at a downgraded quality comprises means for reducing the resolution of images included in the content item.

16. The system of claim 11, wherein the means for transmitting the content item at an impaired quality comprises means for reducing the size of one or more images included in the content item.

17. The system of claim 11, wherein the means for transmitting the content item at an impaired quality comprises means for increasing the distortion of audio signals included in the content item.

18. The system of claim 11, wherein the means for transmitting the content item at an impaired quality comprises means for interrupting transmission of the content item.

19. The system of claim 11, further comprising means for transmitting a request for additional individual user payments to the plurality of users when the total collective payment is less than the collective earning threshold.

20. The system of claim 11, further comprising means for transmitting a request for additional individual user payments to the plurality of users when the total collective payment is within a predetermined range of the collective earning threshold.

21. A computer program product comprising a computer useable medium having computer program logic recorded thereon for enabling a processor in a computer system to provide a content item over a network to a plurality of users, the computer program logic comprising:
program code for enabling the processor to receive one or more individual user payments;
program code for enabling the processor to compare a sum of the individual user payments to a collective earning threshold;
program code for enabling the processor to transmit the content item at a premium quality level when the total collective payment is greater than or equal to the collective earning threshold; and
program code for enabling the processor to transmit the content item at an impaired quality level when the total collective payment is less than the collective earning threshold.

22. A method of providing a content item to a plurality of users, comprising:
defining a collective earning threshold;
receiving a total collective payment from the plurality of users, wherein the total collective payment includes a plurality of individual user payments that are each contributed by a respective one of the plurality of users; and
scheduling the content item for transmission when the total collective payment is greater than or equal to the collective earning threshold.

23. The method of claim 22, further comprising the step of
identifying a stale payment when the total collective payment is less than the collective earning threshold; and
providing a content item reselection opportunity to the user that placed the stale payment.

24. A system for providing a content item to a plurality of users, comprising:
means for defining a collective earning threshold;
means for receiving a total collective payment from the plurality of users, wherein the total collective payment includes a plurality of individual user payments that are each contributed by a respective one of the plurality of users; and
means for scheduling the content item for transmission when the total collective payment is greater than or equal to the collective earning threshold.

25. A computer program product comprising a computer useable medium having computer program logic recorded thereon for enabling a processor in a computer system to provide a content item over a network to a plurality of users, the computer program logic comprising:
program code for enabling the processor to define a collective earning threshold;
program code for enabling the processor to receive a total collective payment from the plurality of users, wherein the total collective payment includes a plurality of individual user payments that are each contributed by a respective one of the plurality of users; and
program code for enabling the processor to schedule the content item for transmission when the total collective payment is greater than or equal to the collective earning threshold.

26. A method of providing a content item to a plurality of users, comprising:
defining a collective earning threshold;
receiving a total collective payment from the plurality of users, wherein the total collective payment includes a plurality of individual user payments that are each contributed by a respective one of the plurality of users; and
transmitting the content item in a manner that is based on a comparison between the total collective payment and the collective earning threshold.

27. A wireless communications device for receiving a content item from a content provider, the wireless communications device comprising:
means for selecting a content item from a list of content item offerings provided by the content provider;
means for sending an individual user payment for the selected content item to the content provider;
means for receiving a revenue indicator from the content provider, the revenue indicator indicating a comparison between a total collective payment and a collective earning threshold, wherein the total collective payment includes the individual user payment and one or more payments from other wireless communications devices; and
means for receiving the selected content item from the content provider in a manner that is determined by the comparison between the total collective payment and the collective earning threshold.
